(19) United States
(12) Patent Application Publication
(10) Pub. No.: US 2008/0278062 A1
(43) Pub. Date: Nov. 13, 2008

(54) METHOD OF FABRICATING ELECTRON EMISSION SOURCE, ELECTRON EMISSION DEVICE, AND ELECTRON EMISSION DISPLAY DEVICE INCLUDING THE ELECTRON EMISSION DEVICE

(75) Inventors: Hee-Sung MOON, Suwon-si (KR); Jae-Myung KIM, Suwon-si (KR); Yoon-Jin KIM, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/865,208

(22) Filed: Oct. 1, 2007

(30) Foreign Application Priority Data
May 10, 2007 (KR) 2007-45365

(51) Int. Cl. H01J 1/62; H01J 9/02; B05D 5/12

(52) U.S. Cl. 313/498; 445/50; 327/77

(57) ABSTRACT

A method is provided for fabricating an electron emission source which can attain improved electron emission efficiency and has simplified manufacturing processes. Also provided are an electron emission display device and an electron emission display device fabricated using the method of fabricating an electron emission source. The method includes forming an electrode, forming a carbide compound thin film on the electrode and forming a carbide-induced carbon thin film layer from the carbide compound thin film using an etching gas. The electron emission device and the electron emission display device each include a first electrode, a second electrode disposed to face the first electrode, and a carbide-induced carbon thin film layer formed to be electrically connected to f the first electrode or the second electrode.

### CROSS-REFERENCE TO RELATED APPLICATIONS

This application claims the benefit of Korean Application No. 2007-45365, filed May 10, 2007, in the Korean Intellectual Property Office, the disclosure of which is incorporated herein in by reference.

### BACKGROUND OF THE INVENTION

1. Field of the Invention

Aspects of the present invention relate to electron emission, and more particularly, to a method of fabricating an electron emission source having improved electron emission efficiency, an electron emission device including the electron emission source fabricated using the method, and an electron emission display device including the electron emission device.

2. Description of the Related Art

Generally, electron emission devices use a hot cathode or a cold cathode as an electron emission source. Examples of electron emission devices using a cold cathode include a field emitter array (FEA) type, a surface conduction emitter (SCE) type, a metal insulator metal (MIM) type, a metal insulator semiconductor (MIS) type, and a ballistic electron surface emitting (BSE) type.

The FEA type utilizes the principle that when a material with a low work function or a high β function is used as an electron emission source, electrons are easily emitted in a vacuum due to an electric field difference. Devices including a tip structure primarily composed of Mo, Si, etc. and having a sharp end have been developed, and carbon-based materials such as graphite, diamond like carbon (DLC), etc. have been developed as electron emission sources. Recently, nanomaterials such as nanotubes and nanowires have been used as electron emission sources.

The SCE type is formed by interposing a conductive thin film between a first electrode and a second electrode which are arranged on a first substrate so as to face each other and to produce microcracks in the conductive thin film. When voltages are applied to the first and second electrodes, an electric current flows along the surface of the conductive thin film, and electrons are emitted from the microcracks thus constituting electron emission sources.

The MIM type and the MIS type include a metal-insulator-metal structure and a metal-insulator-semiconductor structure, respectively, as an electron emission source. When voltages are applied to the two metals in the MIM type or to the metal and the semiconductor in the MIS type, electrons are emitted while migrating and accelerating from the metal or the semiconductor having a high electron potential to the metal having a low electron potential.

The BSE type utilizes the principle that when the size of a semiconductor is reduced to less than the mean free path of electrons in the semiconductor, electrons travel without scattering. An electron-supplying layer composed of a metal or a semiconductor is formed on an ohmic electrode, and then an insulating layer and a metal thin film are formed on the electron-supplying layer. When voltages are applied to the ohmic electrode and the metal thin film, electrons are emitted.

Recently, FED type electron emission devices have been formed of a material having a large aspect ratio and composed mainly of a carbon-based material, as described above. When an electron emission source formed of a carbon-based material is fabricated using a printing method with a known paste or direct epitaxy by way of chemical vapor deposition (CVD), it is difficult to attain improved electron emission efficiency, or the manufacturing process is complicated. These are obstacles in realizing widespread use of the FED type electron emission devices. Accordingly, there is a need to develop a method of fabricating an electron emission source which has improved electron emission efficiency and simplified manufacturing processes.

### SUMMARY OF THE INVENTION

Aspects of the present invention provide a method of fabricating an electron emission source which can attain improved electron emission efficiency and has simplified manufacturing processes.

Aspects of the present invention also provide an electron emission device and an electron emission display device fabricated using the method of fabricating an electron emission source.

Another aspect of the present invention provides a method of fabricating an electron emission source, including: i) forming an electrode; ii) forming a carbide compound thin film on the electrode; and iii) forming a carbide-induced carbon thin film layer from the carbide compound thin film using an etching gas.

The carbide compound may be a compound of carbon and an atom of group II, III, IV, V or VI. The carbide compound may be at least one compound selected from the group including a diamond-based carbide such as SiC, B₄C or Mo₂C; a metal-based carbide; a salt-based carbide such as Al₄C₃ or CaC₂; a complex carbide; and a carbonitride. The etching gas may be a halogen containing gas such as chlorine (Cl₂), TiCl₄, F₂, Br₂, I₂, HCl or a mixture thereof.

Another aspect of the present invention provides an electron emission device including: i) a first electrode; ii) a second electrode disposed to face the first electrode; and iii) a carbide-induced carbon thin film layer formed to be electrically connected either to the first electrode or the second electrode. The electron emission device may further include a carbide compound thin film interposed between the carbide-induced carbon thin film layer and the first electrode or the second electrode that is electrically connected to the carbide-induced carbon thin film layer.

Another aspect of the present invention provides an electron emission display device including: i) a cathode; ii) a carbide-induced carbon thin film layer formed to be connected to the cathode; iii) a phosphor layer disposed in front of the carbide-induced carbon thin film layer; and iv) an anode disposed in front of the carbide-induced carbon thin film layer, wherein electrons emitted from the carbide-induced carbon thin film layer are accelerated toward the phosphor layer.

A plurality of cathodes may be disposed on a base substrate and a plurality of gate electrodes are disposed to face the cathodes so that electron emission from the carbide-induced carbon thin film layer is controlled by a voltage applied to the gate electrodes. The cathodes and the gate electrodes may be disposed to cross each other, and a plurality of carbide-induced carbon thin film layers are formed in areas in which the cathodes and the gate electrodes cross so that a specific carbide-induced carbon thin film layer of the plurality of carbide-induced carbon thin film layers, from which electrons are to be emitted, can be selected during operation of the device.

The electron emission display device may further include a first insulating layer formed between the cathodes and the gate electrodes; and a focusing electrode to which a predetermined negative (−) voltage is applied so as to focus electrons emitted from the carbide-induced carbon thin film layer. The electron emission display device may further include a carbide compound thin film interposed between the carbide-induced carbon thin film layer and the cathode.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view illustrating an electron emission display device according to an example embodiment of the present invention;

FIG. 2 is an enlarged view illustrating part II of FIG. 1;

FIG. 3 is a schematic cross-sectional view illustrating an electron emission display device including an electron emission device, according to an example embodiment of the present invention;

FIG. 4 is a partial perspective view illustrating an electron emission display device including an electron emission device, according to another example embodiment of the present invention;

FIG. 5 is a cross-sectional view of an electron emission display device taken along line V-V of FIG. 4;

FIG. 6 is a partial perspective view illustrating an electron emission display device including an electron emission device, according to another example embodiment of the present invention; and

FIG. 7 is a cross-sectional view of an electron emission device taken along line VII-VII of FIG. 6.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Hereinafter, a method of fabricating an electron emission source according to aspects of the present invention will be described, and an electron emission device fabricated by the method of fabricating an electron emission source and an electron emission display device having the electron emission source will also be described more fully with reference to the accompanying drawings.

The method of fabricating an electron emission source according to aspects of the present invention includes forming an electron emission source on a conductive material which may be used as an electrode. Such an electron emission source may be obtained by forming an electrode on a base substrate, forming a carbon-based material thin film layer on the electrode and forming a porous carbon thin film having a plurality of nano pores on a surface of the carbon-based material thin film layer using an etching process. Each of the nano pores may have a diameter in the range of 1 to 1000 nm, preferably, 2 through 10 nm, and the arrangement of the nano pores may be regular or irregular.

When the electron emission source is fabricated using such method, the fabrication process is simpler and subsequent processes are not required as compared with a printing method using paste or a method of fabricating a carbon nano tube electron emission source by direct epitaxy using chemical vapor deposition (CVD).

More specifically, such a method of fabricating an electron emission source according to an example embodiment of the present invention will be described as follows. First, a first electrode is formed on a base substrate. The first electrode may be formed of conductive paste using a printing method. Next, a carbide compound thin film is formed on the first electrode. The carbide compound is a compound of carbon and an atom of group II, III, IV, V or VI, preferably a diamond-based carbide such as SiC B₄C or Mo₂C; a metal-based carbide such as TiC, TaC, WC, MoC or ZrC; a salt-based carbide such as Al₄C₃ or CaC₂; a complex carbide such as TiₓTa_{y}C or MoₓW_{y}C; a carbonitride such as TiNₓC_{y} or ZrNₓC_{y}; or a mixture of the above carbide materials. In the above carbide materials, the subindex ‘y’ may be equal to ‘1−x’. In this case, ‘x’ is greater than 0 and is smaller than 1. The thin film may be formed using various methods such as physical vapor deposition (PVD), CVD, sputtering or the like.

Next, the metal included in the carbide compound is removed by allowing a halogen containing gas that can etch the metal to flow over and contact the carbide compound. The halogen containing gas may be a gas such as chlorine (Cl₂), TiCl₄, F₂, Br₂, I₂, HCl or the like, or a mixture thereof.

When the metal is removed, a carbide-induced carbon thin film having a plurality of nano pores formed thereon is formed. The diameter of each of the nano pores may be in the range of 1 to 1000 nm, preferably, 2 through 10 nm. The arrangement of the nano pores may be regular or irregular. Since the carbide-induced carbon thin film is formed on a surface of the carbide compound thin film, some metal may remain inside the carbide compound thin film.

When the metal carbide thin film is formed of SiC, and the halogen containing gas is Cl₂, a reaction occurs according to the following formula (1).

SiC+2Cl₂=>SiCl₄+C (1)

When the metal carbide thin film is formed of SiC, and the halogen containing gas is HCl, a reaction occurs according to the following formula (2).

SiC+4HCl=>SiCl₄+C+2H₂ (2)

The above described method is used in fabricating various electron emission devices having various forms as described below.

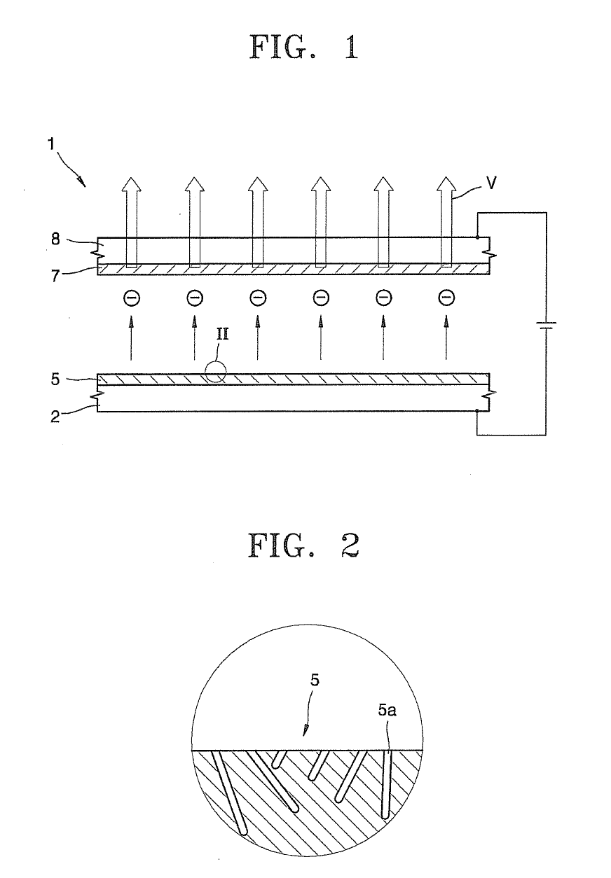

Turning now to FIG. 1, an electron emission display device 1 fabricated using a method of fabricating an electron emission source 5, according to an example embodiment of the present invention is illustrated. FIG. 2 is an enlarged view illustrating part II of FIG. 1, that is, FIG. 2 is a schematic view illustrating the surface of the carbide-induced carbon thin film layer.

Referring to FIG. 1, in the electron emission display device 1 according to an example embodiment of the present invention, an electron emission source 5 is formed on a cathode 2. The electron emission source 5 may be a carbide-induced carbon thin film layer formed on cathode 2 using the above described method. Referring to FIG. 2, the carbide-induced carbon thin film has a plurality of nano pores 5a formed therein, and the diameter of each of the pores 5a may be in the rage of 1 to 1000 nm. The carbide-induced carbon thin film may be formed from a carbide compound.

A phosphor layer 7 and an anode 8 are arranged to oppose the electron emission source 5. The cathode 2 and the anode 8 may be formed of a common conductive material, for example, metals such as Al, Ti, Cr, Ni, Au, Ag, Mo, W, Pt, Cu, Pd or the like, or an alloy thereof, or alternatively, a printed conductor formed of a metal or metal alloy such as Pd, Ag, Pd—Ag or the like, or a metal oxide such as RuO₂ or the like or glass. Alternatively, the cathode 2 and the anode 8 may be formed of a transparent conductor such as ITO, In₂O₃, SnO₂ or the like, or a semiconductor material such as polysilicon or the like.

The phosphor layer 7 is formed of cathode luminescence (CL) type phosphor and can be excited by accelerated electrons to generate visible rays. The phosphor used to form the phosphor layer 7 may be a phosphor for red light such as SrTiO₃:Pr, Y₂O₃:Eu, Y₂O₃S:Eu or the like, a phosphor for green light such as Zn(Ga,Al)₂O₄:Mn, Y₃(Al,Ga)₅O₁₂:Tb, Y₂SiO₅:Tb, ZnS:Cu,Al or the like, or a phosphor for blue light such as Y₂SiO₅:Ce, ZnGa₂O₄, ZnS:Ag, Cl or the like, but the present invention is not limited thereto.

A vacuum should be maintained in the space formed between the phosphor layer 7 and the electron emission source 5 so that the electron emission display device 1 can operate normally. To achieve this, a spacer (not shown) maintaining an interval between the phosphor layer 7 and the electron emission source 5 and glass frit (not shown) sealing the vacuum space are further used. The glass frit seals the vacuum space by being disposed around the vacuum space.

In the electron emission display device 1 having the above structure, when a negative (−) voltage is applied to the cathode 2 and a positive (+) voltage is applied to the anode 8, electrons are emitted from the electron emission source 5 toward the anode 8 (the electrons and arrows shown on FIG. 1 without reference numbers). Of course, when a positive (+) voltage is applied to the cathode 2 and the voltage applied to the anode 8 is a positive (+) voltage of higher magnitude than the voltage applying to the cathode 2, electrons can be also emitted. More particularly, while nano size pores formed on the surface of the carbide-induced carbon thin film layer formed on a surface of the electron emission source 5 are functioning as an electron path, electrons are emitted. Such phenomenon is similar to a point discharge phenomenon where a nano material such as a nanotube having a large aspect ratio emits electrons when an electric field is generated on the nano material. The carbide-induced carbon thin film layer has a different structure from a carbon nanotube. However, the carbide-induced carbon thin film layer is the same as the carbon nanotube in that when an electric field is generated, the carbon nanotube emits electrons. The emitted electrons are accelerated toward the anode 8 and excite the phosphor layer 7 formed adjacent to the anode 8 to emit visible rays, reference number Roman Numeral V.

The electron emission display device 1, as shown in FIG. 1, may be used as a backlight unit of a non-emissive display device such as TFT-LCD, and may also be used as an electron emission display device of a type which can control electron emission quantity through a low gate voltage by further forming an additional electrode, as described below. That is, a method of fabricating an electron emission source according to an aspect of the present invention and the electron emission source fabricated using the method may be formed in an electron emission display device that emits electrons when an electric field is generated between a gate electrode and a cathode and accelerates the electrons by a voltage applied to an anode, as described below in detail.

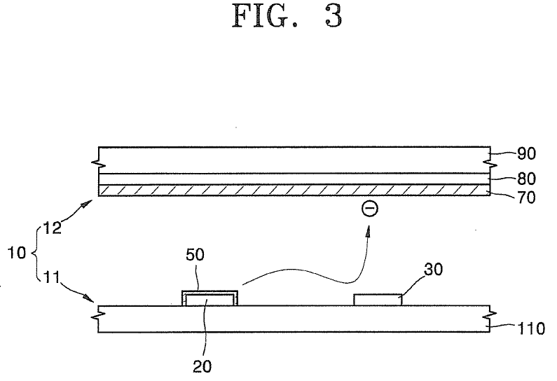

FIG. 3 is a schematic cross-sectional view illustrating an electron emission display device 10 including an electron emission device 11 according to an example embodiment of the present invention. The electron emission device 11 includes a base substrate 110, a first electrode 20, a second electrode 30 and an electron emission source 50. The base substrate 110 is a plate member having a predetermined thickness, and may be a quartz glass substrate, a glass substrate containing a small quantity of trace additives such as Na, a glass plate, a glass substrate coated with SiO₂, an oxide aluminum substrate or a ceramic substrate. In addition, a flexible material may be used in order to form a flexible display apparatus.

The first electrode 20 and the second electrode 30 are alternately spaced at predetermined intervals in one direction, and may be formed of a common conductive material, for example, a metal such as Al, Ti, Cr, Ni, Au, Ag, Mo, W, Pt, Cu, Pd or the like, or an alloy thereof such as the material for forming the cathode 2 and the anode 8 illustrated in FIG. 1, or alternatively, a metal or metal alloy such as Pd, Ag, Pd—Ag or the like, a metal oxide such as RuO₂ or the like, or a printed conductor formed of a metal or metal oxide and glass. Alternatively, the first electrode 20 and the second electrode 30 may be formed of a transparent conductor such as ITO, In₂O₃, SnO₂ or the like, or a semiconductor material such as polysilicon or the like.

The electron emission source 50 is formed so as to cover at least a part of surfaces of the first electrode 20 and/or the second electrode 30. The electron emission source 50, which may be fabricated using the above-described method of fabricating the electron emission source, is formed to have a carbide-induced carbon thin film layer on the surface thereof. The structure of the carbide-induced carbon thin film layer is the same as described above. In addition, a carbide compound thin film having conductivity may be interposed between the carbide-induced carbon thin film layer and the first electrode 20 or the second electrode 30. When the carbide compound thin film is interposed between the carbide-induced carbon thin film layer and the first electrode 20 or the second electrode 30, it is easy to control the thickness of the carbide compound thin film to be etched to form the carbide-induced carbon thin film layer, and the time for etching the surface of the carbide compound thin film to form the carbide-induced carbon thin film layer need not be long. Accordingly, process efficiency can be improved.

In the electron emission device having the above-described structure, electrons are emitted by an electric field generated between the first electrode 20 and the second electrode 30. When the carbide-induced carbon thin film layer is formed on both of the first electrode 20 and the second electrode 30, the first electrode 20 and the second electrode 30 may alternately share functions. Thus, the lifetime of the electron emission device can be improved.

Meanwhile, the electron emission device having the above structure may function as an electron emission display device 10 by forming a vacuum space defined between the electron emission device 11 and a front panel 12 including a phosphor layer 70 as illustrated in FIG. 3. In such a case, an anode 80 is formed on a substrate 90 of the front panel 80 which anode 80 accelerates electrons emitted from the carbide-induced carbon thin film layer toward the phosphor layer 7. In the electron emission device 11 having the above-described structure, electron emission can be controlled by the first electrode 20 and the second electrode 30 to which lower voltages are applied than that applied to the anode 8, unlike the electron emission display device illustrated in FIG. 1, and accordingly, electron emission efficiency can be improved.

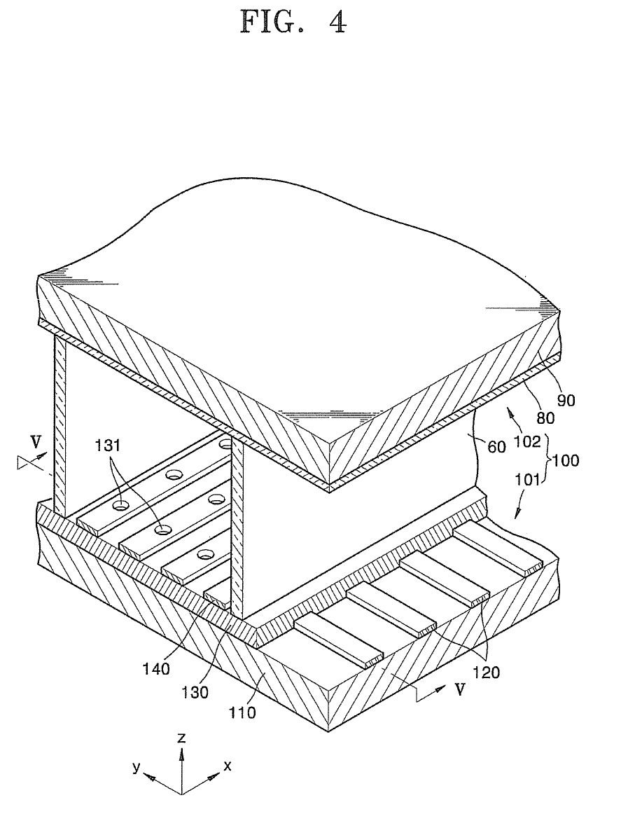

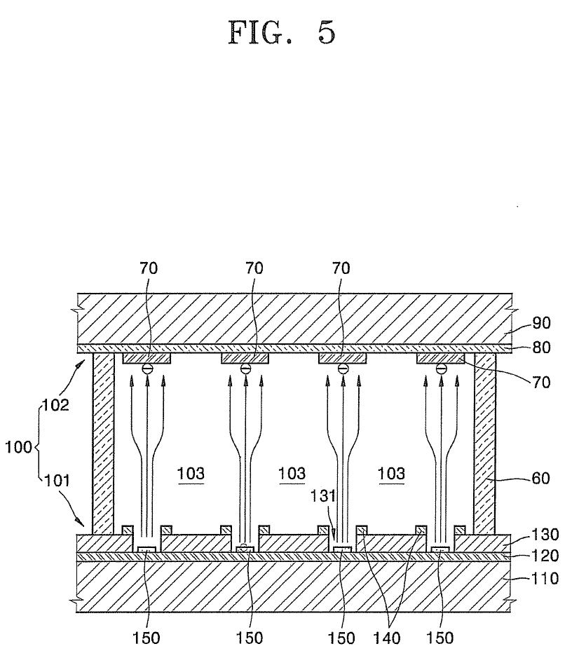

FIG. 4 is a partial perspective view illustrating an electron emission display device 100 including an electron emission device 101, according to another example embodiment of the present invention. FIG. 5 is a cross-sectional view of the electron emission device 101 taken along line V-V line of FIG. 4. In FIGS. 4 and 5, the electron emission device 101 includes a base substrate 110, a plurality of cathodes 120, a first insulating layer 130, a plurality of gate electrodes 140, and a plurality of electron emission sources 150 (see FIG. 5).

The base substrate 110 is a plate member having a predetermined thickness, and may be a quartz glass substrate, a glass substrate containing a small quantity of trace additives such as Na, a glass plate, a glass substrate coated with SiO₂, an aluminum oxide substrate or a ceramic substrate. In addition, a flexible material may be used in order to embody a flexible display apparatus.

The cathodes 120 are disposed on the base substrate 110 to extend in one direction, and may be formed of a common conductive material, for example, a metal such as Al, Ti, Cr, Ni, Au, Ag, Mo, W, Pt, Cu, Pd or the like, or an alloy thereof such as has been described as a material for forming the first electrode 20 and the second electrode 30 of the electron emission device illustrated in FIG. 3, or alternatively, a metal or metal alloy such as Pd, Ag, Pd—Ag, or the like, a metal oxide such as RuO₂ or the like, or a printed conductor formed of a metal or metal oxide and glass. Alternatively, the cathodes 120 may be formed of a transparent conductor such as ITO, In₂O₃, SnO₂ or the like, or a semiconductor material such as polysilicon or the like.

The gate electrodes 140 are disposed on the first insulating layer 130, wherein the first insulating layer 130 is disposed on the cathodes 120, and the gate electrodes 140 may be formed of a common conductive material similar to the cathodes 120.

The first insulating layer 130 is disposed between the gate electrodes 140 and the cathodes 120 to insulate the cathodes 120 and the gate electrodes 140, and accordingly, prevents short circuits between the cathodes 120 and the gate electrodes 140.

Each electron emission source 150 is a carbide-induced carbon thin film layer formed on one of the cathodes 120, and the carbide-induced carbon thin film layer may be fabricated using the above-described method of fabricating the electron emission source according to the present invention. The electron emission source 150 is formed to have a plurality of nano pores formed therein to function as electron emission paths.

In the electron emission device 101 having the above structure, when a negative (−) voltage is applied to the cathodes 120, and a positive (+) voltage is applied to the gate electrodes 140, electrons are emitted from the electron emission sources 150 by an electric field generated between the cathodes 120 and the gate electrodes 140. Of course, when a positive (+) voltage is applied to the cathodes 120 and the voltage applied to the gate electrodes 140 is a positive (+) voltage of a higher magnitude than the voltage applied to the cathode 2, electrons can be also emitted.

In addition, the electron emission device 101 can be used in an electron emission display device 100 that can generate visible rays and display images. In order to form the electron emission display device 100, a phosphor material is disposed in front of the electron emission sources 150 of the electron emission device 101. To achieve this, the electron emission display device 100 further includes a front panel 102 disposed parallel to the base substrate 110 of the electron emission device 101, and the front panel 102 further includes a front substrate 90, an anode 80 formed on the front substrate 90 and a phosphor layer 70 formed on the anode 80.

The front substrate 90 is a plate member having a predetermined thickness like the base substrate 110, and may be formed of the same material as that of the base substrate 110. The anode 80 is formed of a common conductive material like the cathodes 120 and the gate electrodes 140. The phosphor layer 70 is formed of cathode luminescence (CL) type phosphor that can be excited by accelerated electrons to generate visible rays. A phosphor material for forming the phosphor layer 70 may be the phosphor material that has been described above with reference to the backlight unit. Of course, the present invention is not limited thereto.

In order to display an image rather than emit visible rays as a simple lamp, or to comprise a backlight unit having a dimming function, a plurality of cathodes 120 and a plurality of gate electrodes 140 may be disposed to cross each other in the form of a matrix.

Electron emission source holes 131 (i.e., vias) are formed in areas in which the gate electrodes 140 and the cathodes 120 cross, and the electron emission sources 150 are disposed inside each of the electron emission source holes 131.

The electron emission device 101 including the base substrate 110 and the front panel 102 including the front substrate 90 are maintained at a predetermined interval to face each other, and define a light emitting space. In addition, spacers 60 are disposed in order to maintain the interval between the electron emission device 101 and the front panel 102. The spacers 60 may be formed of an insulating material.

In order to maintain vacuum, frit is sealed around a space defined by the electron emission device 101 and the front panel 102, and a vacuum is formed in the light emitting space. The electron emission display device 100 having the above structure is operated as follows.

A negative (−) voltage and a positive (+) voltage are applied to the cathodes 120 and the gate electrodes 140, respectively, so that electrons may be emitted from the electron emission source 150 formed on the cathodes 120. In addition, a higher positive (+) voltage is applied to the anode 80, and thus the emitted electrons are accelerated toward the anode 80 (the arrows and electrons shown without reference numbers in FIG. 5). When a voltage is applied like this, electrons are emitted from materials included in the electron emission sources 150 pointed toward the gate electrodes 140 and are accelerated toward the anode 80. When the electrons accelerated toward the anode 80 collide with the phosphor layer 70 placed on the anode 80, the phosphor layer 70 is excited to emit visible rays.

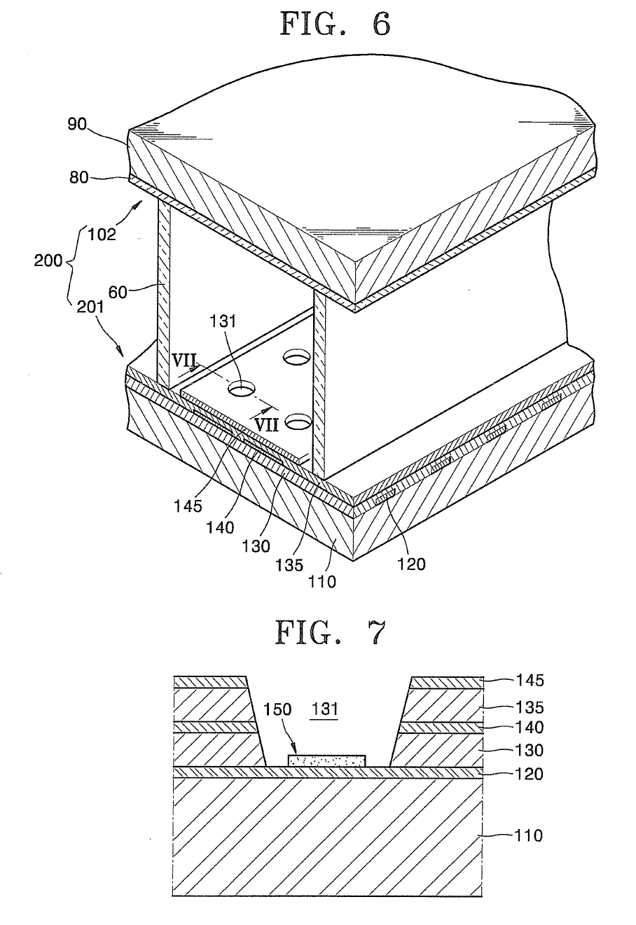

FIG. 6 is a partial perspective view illustrating an electron emission device 201 and an electron emission display device 200 including the electron emission device 201, according to another embodiment of the present invention. FIG. 7 is a cross-sectional view of the electron emission device 201 taken along line VII-VII line of FIG. 6.

The electron emission device 201 includes the electron emission device 101 illustrated in FIGS. 6 and 7 and a focusing electrode 145. That is, the electron emission device 201 further includes a second insulating layer 135 formed over the gate electrodes 140 and the focusing electrode 145 formed on the second insulating layer 135. The focusing electrode 145 focuses electrons emitted from each of the electron emission sources 150 toward a phosphor layer, and prevents the electrons from being dispersed in right and left directions. In the current embodiment of the present invention, the electron emission sources 150 can be fabricated to be of a carbide-induced carbon thin film layer type using the method of fabricating an electron emission source according to the present invention. When the electron emission sources 150 are fabricated using the method of fabricating an electron emission source according to the present invention, the electron emission source holes 131 are formed in the gate electrodes 140, a carbide compound thin film is formed for forming an electron emission source on portions of the cathodes 120 exposed through the electron emission source holes 131, and a carbide-induced carbon thin film layer is formed using an etching gas such as Cl₂.

An electron emission source can be efficiently fabricated using the method of fabricating an electron emission source according to the present invention since processes included in the method are simplified. In addition, due to improved electron emission efficiency of a carbide-induced carbon thin film layer, energy consumption can be reduced and brightness of an electron emission display device can be improved.

In an electron emission device including an electron emission source fabricated by the method of fabricating an electron emission source according to the present invention, and an electron emission display device including the electron emission device, the electron emission source can be efficiently fabricated using the method since processes included in the method are simplified. In addition, due to improved electron emission efficiency of a carbide-induced carbon thin film layer, energy consumption can be reduced and brightness of an electron emission display device can be improved.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of fabricating an electron emission source, comprising:
forming an electrode;
forming a carbide compound thin film on the electrode; and
forming a carbide-induced carbon thin film layer from the carbide compound thin film using an etching gas.

2. The method of claim 1, wherein the carbide compound of the carbide compound thin film is a compound of carbon and an atom of group II, III, IV, V or VI.

3. The method of claim 2, wherein the carbide compound of the carbide compound thin film is at least one carbide compound selected from the group including a diamond-based carbide; a metal-based carbide; a salt-based carbide; a complex carbide; and carbonitride.

4. The method of claim 1, wherein the etching gas is a halogen containing gas selected from the group including chlorine (Cl₂), TiCl₄, F₂, Br₂, I₂, HCl or a mixture thereof.

5. The method of claim 1, wherein the carbide-induced carbon thin film layer is formed to include a plurality of nano pores on a surface thereof, each having a mean diameter in the range of 2 through 10 nm.

6. An electron emission device comprising:
a substrate;
a first electrode formed on the substrate;
a second electrode disposed to oppose the first electrode; and
a carbide-induced carbon thin film layer formed to be electrically connected to at least one of the first electrode and the second electrode.

7. The electron emission device of claim 6, further comprising:
a carbide compound thin film interposed between the carbide-induced carbon thin film layer and the first electrode or the second electrode that is electrically connected to the carbide-induced carbon thin film layer.

8. An electron emission display device comprising:
a cathode;
a carbide-induced carbon thin film layer formed to be connected to the cathode;
a phosphor layer disposed in front of the carbide-induced carbon thin film layer; and
an anode disposed in front of the carbide-induced carbon thin film layer, wherein electrons emitted from the carbide-induced carbon thin film layer are accelerated toward the phosphor layer.

9. The electron emission display device of claim 8, further comprising:
a plurality of cathodes are disposed on a base substrate; and
a plurality of gate electrodes disposed to oppose the cathodes so that electron emission from the carbide-induced carbon thin film layer is controlled by a voltage applied to the gate electrodes.

10. The electron emission display device of claim 9, wherein the cathodes and the gate electrodes are disposed to cross each other, and a plurality of carbide-induced carbon thin film layers are formed in areas in which the cathodes and the gate electrodes cross so that a specific one of the carbide-induced carbon thin film layers, from which electrons are to be emitted, is selected.

11. The electron emission display device of claim 10, further comprising:
a first insulating layer formed between the cathodes and the gate electrodes; and
a focusing electrode to which a predetermined negative (−) voltage is applied so as to focus electrons emitted from the carbide-induced carbon thin film layer.

12. The electron emission display device of claim 8, further comprising:
a carbide compound thin film interposed between the carbide-induced carbon thin film layer and the cathode.

13. The method of claim 3, wherein:
the diamond-based carbide is selected from the group including SiC B₄C and Mo₂C;
the metal-based carbide is a compound selected from the group including TiC, TaC, WC, MoC and ZrC;
the salt-based carbide is a compound selected from the group including Al₄C₃ and CaC₂;
the complex carbide is a compound selected from the group including TiₓTa_{y}C and MoₓW_{y}C, the subindex ‘y’ is equal to ‘1−x’ and ‘x’ is greater than 0 and is smaller than 1; and
the carbonitride is a compound selected from the group including TiNₓC_{y} and ZrNₓC_{y}, the subindex ‘y’ is equal to ‘1−x’ and ‘x’ is greater than 0 and is smaller than 1.

14. The method of claim 1, wherein the carbide compound thin film is formed by a process selected from the group including physical vapor deposition (PVD), CVD, and sputtering.

15. The method of claim 1, wherein the carbide-induced carbon thin film layer is formed to include a plurality of nano pores on a surface thereof, each having a mean diameter in the range of 1 to 1000 nm.

16. The electron emission device of claim 7, wherein the carbide compound thin film and the carbide-induced carbon thin film cover part of at least one of the first electrode or the second electrode.

17. The electron emission device of claim 6, further comprising:
a plurality of first electrodes disposed on the substrate;
a first insulating layer disposed on the first electrodes and the substrate;
a plurality of second electrodes disposed to face the first electrodes; and
a plurality of carbide-induced carbon thin film layers formed in areas in which the first electrodes and the second electrodes cross each other so that a specific carbide-induced carbon thin film layer of the plurality of carbide-induced carbon thin film layers, from which electrons are to be emitted, is selected.

18. The electron emission device of claim 17, wherein holes are formed through the first insulating layer in the areas where the first electrodes and second electrodes cross, and the carbide-induced carbon thin film layers are disposed in the holes.

19. The electron emission device of claim 17, further comprising:
a second insulating layer disposed on the second electrodes and the first insulating layer; and
a focusing electrode disposed on the second insulating layer,
wherein holes are formed through the first insulating electrode, the second insulating electrode, and the insulating electrode, and the carbide-induced carbon thin film layers are disposed in the holes.
